(19) United States
(12) Patent Application Publication
(10) Pub. No.: US 2014/0035376 A1
(43) Pub. Date: Feb. 6, 2014

(54) UNINTERRUPTIBLE POWER SYSTEM AND METHOD OF OPERATING THE SAME

(71) Applicant: DELTA ELECTRONICS, INC., Taoyuan County (TW)

(72) Inventors: Chia-Hsiang LI, Taoyuan County (TW); Wei-Chun WANG, Taoyuan County (TW); De-Chang JIN, Taoyuan County (TW)

(73) Assignee: DELTA ELECTRONICS, INC., Taoyuan County (TW)

(21) Appl. No.: 13/627,295

(22) Filed: Sep. 26, 2012

(30) Foreign Application Priority Data
Aug. 3, 2012 (TW) 101127879

(51) Int. Cl. H02J 9/00; H02M 3/02; H02M 7/02

(52) U.S. Cl. 307/66

(57) ABSTRACT

An uninterruptible power system includes a power distribution apparatus and an interruptible power apparatus. The power distribution apparatus has a plurality of power supply units, which receive an external AC power and convert the external AC power into a first DC output power to supply a DC load. The interruptible power apparatus has a plurality of power conversion modules, which receive an external DC power and convert the external DC power into a second DC output power to supply the DC load. The DC load is supplied by the first DC output power when the external AC power normally operates; whereas the DC load is supplied by the second DC output power when the external AC power abnormally operates.

This application is based on and claims the benefit of Taiwan Application No. 101127879 filed Aug. 3, 2012 the entire disclosure of which is incorporated by reference herein.

### BACKGROUND

1. Technical Field

The present disclosure relates generally to an uninterruptible power system and a method of operating the same, and more particularly to an uninterruptible power system and a method of operating the same that provide different DC output powers to supply a DC load according to operation conditions of an external AC power.

2. Description of Related Art

Uninterruptible power supply (UPS), as the name indicates, is an electrical apparatus that provides emergency power to a load when the input power source, typically mains power, fails. Because the UPS is more complicated and more expensive than other emergency power apparatuses, the UPS is usually provided to protect important equipment, such as computer equipment, monitor instruments, fire equipment, medical instruments, and so on, thus achieving strict power requirements for the above-mentioned equipment and instruments. In addition, the UPS also provides voltage adjustment once the over-voltage or the under-voltage conditions occur. Furthermore, the UPS can provide good effect for restraining transient fluctuation and harmonic disturbance.

Recently with the rapidly development of information networks, a large number of server power equipment are equipped in the internet data center (IDC) so as to meet the growing information communication network services. However, the large number of equipment leads to extensive power consumptions. In addition, the higher power supply quality needs to be implemented by the uninterruptible power system.

Reference is made to FIG. 1 which is a schematic circuit diagram of a prior art uninterruptible power supply with single power input. An AC UPS apparatus 10A with a power input is an AC uninterruptible power system (AC UPS) and directly electrically connected to an external AC power Vsac, such as an AC utility. A power distribution apparatus 20A is electrically connected to the AC UPS apparatus 10A. The power distribution apparatus 20A has a plurality of power supply units (PSUs) 202_1A˜202_NA and each of the power supply units 202_1A˜202_NA is inserted in the power distribution apparatus 20A via corresponding slots (not shown). When the external AC power Vsac normally operates, the AC UPS apparatus 10A with the single power input receives the external AC power Vsac and the external AC power Vsac is converted into a DC output power Vdc by the power distribution apparatus 20A to supply the required voltage and power of the DC load 30A. Note that, the power supply units 202_1A˜202_NA of the power distribution apparatus 20A are used to convert the external AC power Vsac into the DC output power Vdc to supply the required voltage and power of the DC load 30A. In addition, when the external AC power Vsac abnormally operates, the AC UPS apparatus 10A plays the role of supplying power to provide the AC power to the power distribution apparatus 20A and then the power supply units 202_1A˜202_NA of the power distribution apparatus 20A convert the AC power into the DC output power Vdc to supply the required voltage and power of the DC load 30A.

Although the AC UPS apparatus 10A can play the role of supplying power to elastically provide the AC power to the DC load 30A when the external AC power Vsac abnormally operates, the circuit structure has the following disadvantages:

1. Because the AC UPS apparatus 10A and the power distribution apparatus 20A are separately installed, the required occupied space of the equipment is larger;

2. The additional circuit wirings are required so as to increase costs of materials and labor and reduce assembly efficiency;

3. Once the AC UPS apparatus 10A is failed, the whole AC UPS apparatus 10A needs to be replaced so that the power supply system has to shut down during the replacement of the AC UPS apparatus 10A; and

4. The two-stage power supply structure significantly reduces the power supplying efficiency.

Reference is made to FIG. 2 is a schematic circuit diagram of another prior art uninterruptible power supply with single power input. A power distribution apparatus 22A is directly electrically connected to an external AC power Vsac, such as an AC utility. Note that, the power distribution apparatus 22A has a plurality of PSUs with UPS function 222_1A˜222_NA. Comparing to the power supplying structure in FIG. 1, the AC UPS apparatus 10A and the power distribution apparatus 20A are integrated in one system so that the PSUs with UPS function 222_1A˜222_NA are inserted in the power distribution apparatus 22A via corresponding slots (not shown). When the external AC power Vsac normally operates, the power distribution apparatus 22A receives the external AC power Vsac and the external AC power Vsac is converted into a DC output power Vdc by the PSUs with UPS function 222_1A˜222_NA to supply the required voltage and power of the DC load 30A. In addition, when the external AC power Vsac abnormally operates, the power distribution apparatus 22A plays the role of supplying power to convert the received AC power into the DC output power Vdc to supply the required voltage and power of the DC load 30A.

Although the integrated circuit structure can reduce the required occupied the equipment, reduce costs of materials and labor and reduce assembly efficiency, and increase power supplying efficiency, the circuit structure has the following disadvantages:

1. The AC UPS apparatus 10A and the power distribution apparatus 20A are integrated in one system so that output power of the PSUs with UPS function 222_1A˜222_NA is limited;

2. The integrated circuit structure is difficult to be elastically varied; and

3. Once the PSUs 222_1A˜222_NA or the UPS function thereof are failed, the whole PSUs with UPS function 222_1A˜222_NA need to be replaced.

Reference is made to FIG. 3 is a schematic circuit diagram of a prior art uninterruptible power supply with dual power input. A power distribution apparatus 24A is directly electrically connected to an external AC power Vsac, such as an AC utility, and an external DC power Vsdc, such as a battery unit. The power distribution apparatus 24A has a plurality of power supply units 242_1A˜242_NA and the power supply units 242_1A˜242_NA are inserted in the power distribution apparatus 24A via corresponding slots (not shown). When the external AC power Vsac normally operates, the power distribution apparatus 24A receives the external AC power Vsac and the external AC power Vsac is converted into a DC output power Vdc by the power supply units 242_1A˜242_NA to supply the required voltage and power of the DC load 30A. In addition, when the external AC power Vsac abnormally operates, the power distribution apparatus 24A receives the external DC power Vsdc and the external DC power Vsdc is converted into a DC output power Vdc by the power supply units 242_1A˜242_NA to supply the required voltage and power of the DC load 30A.

Although the dual-input power supply structure can reduce the required occupied the equipment and increase elasticity of supplying power to the DC load 30A, the circuit structure has the following disadvantages:

1. The design of supplying AC power and DC power is complicated because of the dual-input structure of the power distribution apparatus 24A; and

2. The installation of the DC power Vsdc (the battery unit) leads to higher equipment costs under low-demand standby power conditions.

Accordingly, it is desirable to provide an uninterruptible power system and a method of operating the same that provide different DC output powers to maintain normally and continually supplying a DC load according to operation conditions of an external AC power.

### SUMMARY

An object of the invention is to provide an uninterruptible power system to solve the above-mentioned problems. Accordingly, the uninterruptible power system includes a power distribution apparatus and an interruptible power apparatus. The power distribution apparatus is electrically connected to an external AC power. The power distribution apparatus includes a plurality of power supply units configured to receive the external AC power and convert the external AC power into a first DC output power to supply a DC load. The interruptible power apparatus is electrically connected to an external DC power. The interruptible power apparatus includes a plurality of power conversion modules configured to receive the external DC power and convert the external DC power into a second DC output power to supply the DC load. The DC load is supplied by the first DC output power when the external AC power normally operates, whereas the DC load is supplied by the second DC output power when the external AC power abnormally operates; and the external AC power and the external DC power are configured to separately and independently supply the DC load.

Another object of the invention is to provide a method of operating an uninterruptible power system to solve the above-mentioned problems. Accordingly, the method includes the following steps: (a) a power distribution apparatus is provided, the power distribution apparatus has a plurality of power supply units and configured to receive an external AC power; (b) an interruptible power apparatus is provided, the interruptible power apparatus has a plurality of power conversion modules and configured to receive an external DC power; (c) the external AC power is converted into a first DC output power by the power supply units to supply a DC load when the external AC power normally operates; and (d) the external DC power is converted into a second DC output power by the power conversion modules to supply the DC load when the external AC power abnormally operates.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic circuit diagram of a prior art uninterruptible power supply with single power input;

FIG. 2 is a schematic circuit diagram of another prior art uninterruptible power supply with single power input;

FIG. 3 is a schematic circuit diagram of a prior art uninterruptible power supply with dual power input;

FIG. 4 is a schematic circuit diagram of an uninterruptible power system according to the present disclosure;

FIG. 5A is a schematic circuit block diagram of operating the uninterruptible power system under a normal condition of an external AC power;

FIG. 5B is a schematic circuit block diagram of operating the uninterruptible power system under an abnormal condition of the external AC power; and

FIG. 6 is a flowchart of a method of operating an uninterruptible power system according to the present disclosure.

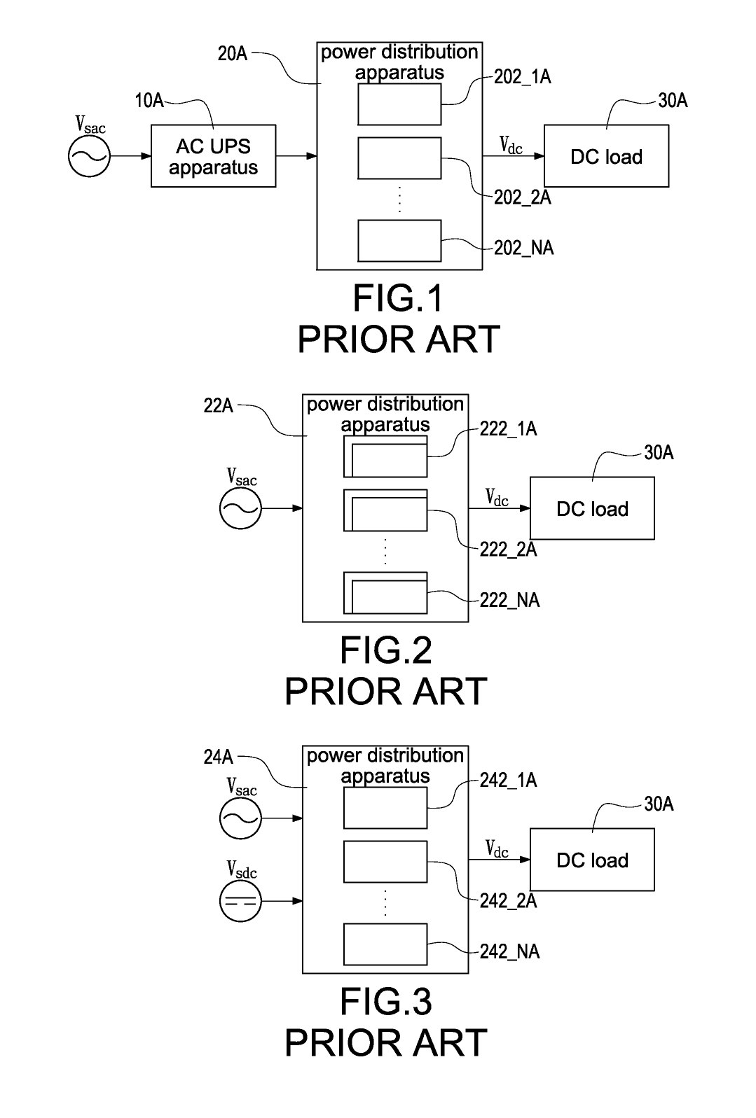

### DETAILED DESCRIPTION

Reference will now be made to the drawing figures to describe the present disclosure in detail.

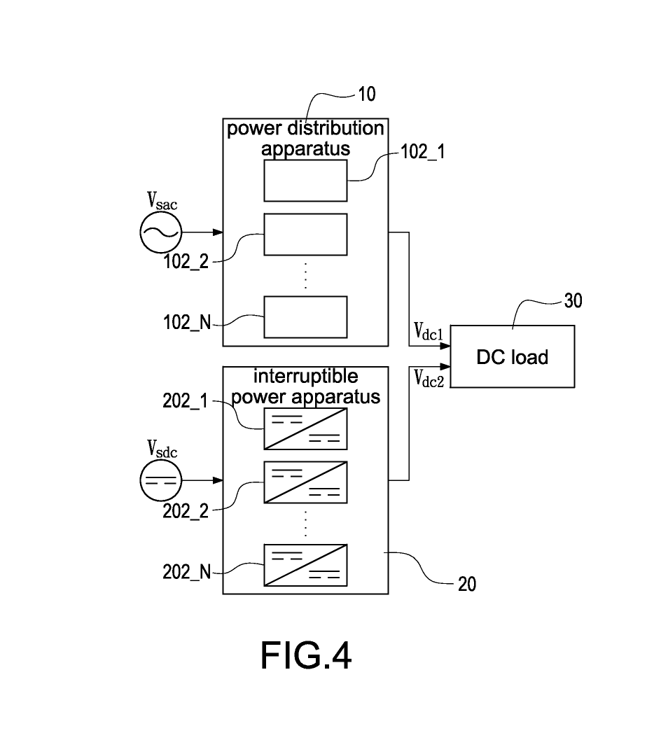

Reference is made to FIG. 4 which is a schematic circuit diagram of an uninterruptible power system according to the present disclosure. The uninterruptible power system includes a power distribution apparatus 10 and an interruptible power apparatus 20. The power distribution apparatus 10 is electrically connected to an external AC power Vsac and the power distribution apparatus 10 has a plurality of power supply units 102_1˜102_N. The interruptible power apparatus 20 is electrically connected to an external DC power Vsdc and the interruptible power apparatus 20 has a plurality of power conversion modules 202_1˜202_N. The power supply units 102_1˜102_N receive the external AC power Vsac and convert the external AC power Vsac into a first DC output power Vdc1 to supply a DC load 30. The power conversion modules 202_1˜202_N receive the external DC power Vsdc and convert the external DC power Vsdc into a second DC output power Vdc2 to supply the DC load 30. In particular, the power conversion modules 202_1˜202_N are inserted in the interruptible power apparatus 20 via corresponding slots (not shown) and can be replaced in a hot swap manner.

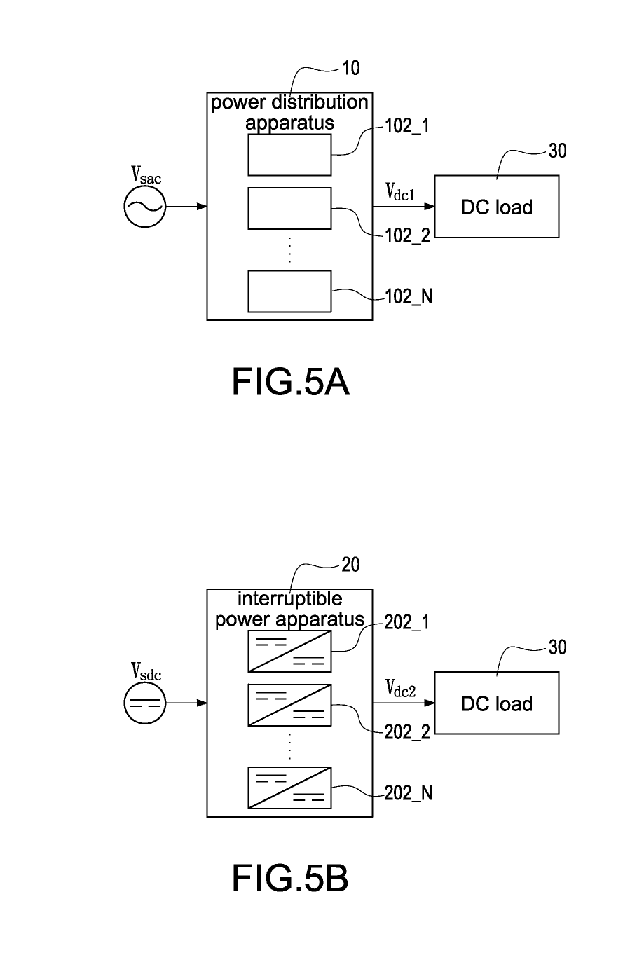

Especially, the power distribution apparatus 10 and the interruptible power apparatus 20 are separately installed so that the external AC power Vsac and the external DC power Vsdc are provided to independently supply the DC load 30. The DC load 30 is supplied by the first DC output power Vdc1 when the external AC power Vsac normally operates, whereas the DC load 30 is supplied by the second DC output power Vdc2 when the external AC power Vsac abnormally operates. Reference is made to FIG. 5A which is a schematic circuit block diagram of operating the uninterruptible power system under a normal condition of an external AC power. As previously stated, the power distribution apparatus 10 is electrically connected to the external AC power Vsac and the power distribution apparatus 10 has the power supply units 102_1˜102_N.

In this embodiment, the power supply units 102_1˜102_N play the role of converting AC power into DC power, that is, the power supply units 102_1˜102_N receive the external AC power Vsac and convert the external AC power Vsac into the first DC output power Vdc1. For example, the power supply units 102_1˜102_N receive a 110-volt AC utility and the power supply units 102_1˜102_N convert the 110-volt AC utility into a 12-volt DC voltage to supply the required voltage and power of the DC load 30. In particular, the power supply units 102_1-102_N are electrically connected in parallel to each other and installed in a modular structure.

In addition, reference is made to FIG. 5B which is a schematic circuit block diagram of operating the uninterruptible power system under a normal condition of an external AC power. As previously stated, the interruptible power apparatus 20 is electrically connected to the external DC power Vsdc and the interruptible power apparatus 20 has the power conversion modules 202_1˜202_N. Note that, each of the power conversion modules 202_1˜202_N is a power converter and the power conversion modules 202_1˜202_N are electrically connected in parallel to each other. The power conversion modules 202_1˜202_N receive the external DC power Vsdc and convert the external DC power Vsdc into the second DC output power Vdc2. For example, the power conversion modules 202_1˜202_N receive a 48-volt DC voltage and the power conversion modules 202_1˜202_N convert the 48-volt DC voltage into a 12-volt DC voltage to supply the required voltage and power of the DC load 30. In particular, the external DC power is generated by a DC power supply apparatus (not shown); the DC power supply apparatus is a rechargeable battery, a fuel cell, or a renewable energy generation apparatus, such as a solar photovoltaic generation apparatus, but not limited. If the DC power supply apparatus is the rechargeable battery, the rechargeable battery is charged by an external charging apparatus (not shown) to generate the external DC power. Hence, the rechargeable battery is electrically connected to the interruptible power apparatus 20 after the rechargeable battery is fully charged by the external charging apparatus so that the uninterruptible power system does not need to additionally install the external charging apparatus. Note that, the interruptible power apparatus 20 (including the external DC supply apparatus) is optional for installation. That is, the interruptible power apparatus 20 (including the external DC supply apparatus) can be removed from supplying power to the DC load 30 when under the low-demand standby power conditions.

As for the detailed operation of coordinating the power distribution apparatus 10 and the interruptible power apparatus 20 is described as follows. The DC load 30 is supply by the first DC output power Vdc1 when the external AC power Vsac normally operates. However, the power distribution apparatus 10 produces a switch control signal to notify the interruptible power apparatus 20 to transfer operation of supplying the DC load 30 when the power distribution apparatus 10 detects that the external AC power Vsac abnormally operates. That is, the responsibility of supplying the DC load 30 is transferred from the power distribution apparatus 10 to the interruptible power apparatus 20, thus maintaining normally and continually supplying the DC load 30. On the other hand, the power distribution apparatus 10 produces a resumption control signal to notify the interruptible power apparatus 20 to transfer operation of supplying the DC load 30 when the power distribution apparatus 10 detects that the external AC power Vsac restores to the normal operation. That is, the responsibility of supplying the DC load 30 is transferred from the interruptible power apparatus 20 to the power distribution apparatus 10 (restore to the power distribution apparatus 10), thus maintaining normally and continually supplying the DC load 30. In addition, each of the power conversion modules 202_1˜202_N of the interruptible power apparatus 20 can be replaced in the hot swap manner. For example, when one of the power conversion modules 202_1˜202_N is damaged, the damaged one is drawn and a normal one is inserted in the hot swap manner during the power supply of the interruptible power apparatus 20.

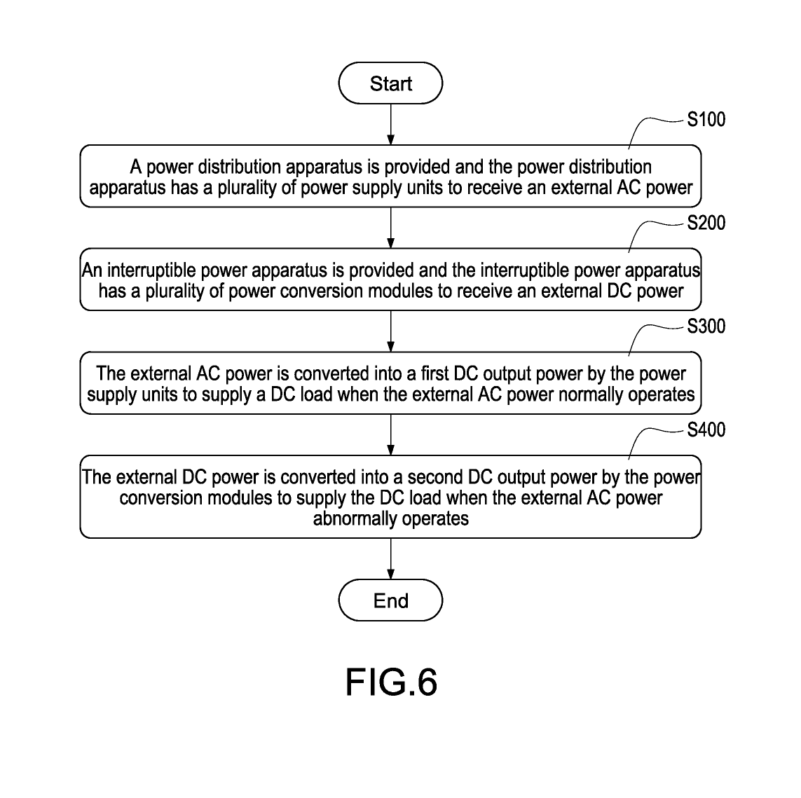

Reference is made to FIG. 6 which is a flowchart of a method of operating an uninterruptible power system according to the present disclosure. The method includes the following steps: A power distribution apparatus is provided, the power distribution apparatus has a plurality of power supply units to receive an external AC power (S100). In particular, the power supply units are electrically connected in parallel to each other and installed in a modular structure. In addition, the external AC power is a 110-volt AC utility. Also, the 110-volt AC utility is converted into a 12-volt DC voltage to supply the required voltage and power of the DC load.

An interruptible power apparatus is provided, the interruptible power apparatus has a plurality of power conversion modules to receive an external DC power (S200). In particular, each of the power conversion modules is a power converter and the power conversion modules are electrically connected in parallel to each other. In addition, the power conversion modules are inserted in the interruptible power apparatus via corresponding slots and can be replaced in a hot swap manner. In addition, the external DC power is a 48-volt DC voltage. Also, the 48-volt DC voltage is converted into a 12-volt DC voltage to supply the required voltage and power of the DC load. In addition, the external DC power is generated by a DC power supply apparatus (not shown) and the DC power supply apparatus can be a rechargeable battery, a fuel cell, or a renewable energy generation apparatus, but not limited. In particular, the renewable energy generation apparatus can be a solar photovoltaic generation apparatus, but not limited. If the DC power supply apparatus is the rechargeable battery, the rechargeable battery is charged by an external charging apparatus (not shown) to generate the external DC power. Hence, the rechargeable battery is electrically connected to the interruptible power apparatus after the rechargeable battery is fully charged by the external charging apparatus so that the uninterruptible power system does not need to additionally install the external charging apparatus. Note that, the interruptible power apparatus (including the external DC supply apparatus) is optional for installation. That is, the interruptible power apparatus (including the external DC supply apparatus) can be removed from supplying power to the DC load when under the low-demand standby power conditions.

Especially, the power distribution apparatus and the interruptible power apparatus are provided to separately and independently supply the DC load. When the external AC power normally operates, the external AC power is converted into a first DC output power by the power supply units to supply a DC load (S300). However, the power distribution apparatus produces a switch control signal to notify the interruptible power apparatus to transfer operation of supplying the DC load when the power distribution apparatus detects that the external AC power abnormally operates. That is, the responsibility of supplying the DC load is transferred from the power distribution apparatus to the interruptible power apparatus, thus maintaining normally and continually supplying the DC load.

When the external AC power abnormally operates, the external DC power is converted into a second DC output power by the power conversion modules to supply the DC load (S400). When the power distribution apparatus detects that the external AC power restores to the normal operation, the power distribution apparatus produces a resumption control signal to notify the interruptible power apparatus to transfer operation of supplying the DC load. That is, the responsibility of supplying the DC load is transferred from the interruptible power apparatus to the power distribution apparatus (restore to the power distribution apparatus), thus maintaining normally and continually supplying the DC load. In addition, each of the power conversion modules of the interruptible power apparatus can be replaced in the hot swap manner. For example, when one of the power conversion modules is damaged, the damaged one is drawn and a normal one is inserted in the hot swap manner during the power supply of the interruptible power apparatus.

In conclusion, the present disclosure has following advantages:

1. The power distribution apparatus 10 and the interruptible power apparatus 20 are directly electrically connected to the external AC power Vsac and the external DC power Vsdc, respectively, to form a single-stage structure of the uninterruptible power system, thus increasing conversion efficiency of the uninterruptible power system;

2. The power supply units 102_1˜102_N of the power distribution apparatus 10 only need to receive a single-supply input (namely, only the external AC power Vsac is received); similarly, the power conversion modules 202_1˜202_N of the interruptible power apparatus 20 also only need to receive a single-supply input (namely, only the external DC power Vsdc is received), thus simplifying the design of supplying AC power and DC power;

3. The interruptible power apparatus 20 is optional for installation according to requirements of users; the interruptible power apparatus 20 can be removed under low-demand standby power conditions, thus saving equipment costs; and

4. Each of the power conversion modules 202_1˜202_N can be replaced in the hot swap manner; when one of the power conversion modules 202_1˜202_N is damaged, the damaged one is drawn and a normal one is inserted in the hot swap manner during the power supply of the interruptible power apparatus 20, thus increasing reliability of power-supply operations.

Although the present disclosure has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An uninterruptible power system comprising:
a power distribution apparatus electrically connected to an external AC power, the power distribution apparatus comprising:
a plurality of power supply units configured to receive the external AC power and convert the external AC power into a first DC output power to supply a DC load; and
an interruptible power apparatus electrically connected to an external DC power, the interruptible power apparatus comprising:
a plurality of power conversion modules configured to receive the external DC power and convert the external DC power into a second DC output power to supply the DC load;
wherein the DC load is supplied by the first DC output power when the external AC power normally operates, whereas the DC load is supplied by the second DC output power when the external AC power abnormally operates; and the external AC power and the external DC power are configured to separately and independently supply the DC load.

2. The uninterruptible power system in claim 1, wherein the power distribution apparatus is configured to produce a switch control signal and send the switch control signal to the interruptible power apparatus to transfer supplying the DC load from the power distribution apparatus to the interruptible power apparatus when the power distribution apparatus detects that the external AC power abnormally operates.

3. The uninterruptible power system in claim 2, wherein the power distribution apparatus is configured to produce a resumption control signal and send the resumption control signal to the interruptible power apparatus to transfer supplying the DC load from the interruptible power apparatus to the power distribution apparatus when the power distribution apparatus detects that the external AC power normally operates.

4. The uninterruptible power system in claim 1, wherein the external DC power is generated by a DC power supply apparatus; the DC power supply apparatus is a rechargeable battery, a fuel cell, or a renewable energy generation apparatus.

5. The uninterruptible power system in claim 4, wherein the rechargeable battery is charged by an external charging apparatus to generate the external DC power.

6. The uninterruptible power system in claim 1, wherein each of the power conversion modules is a power converter and the power conversion modules are electrically connected in parallel to each other.

7. The uninterruptible power system in claim 1, wherein the power conversion modules are inserted in the interruptible power apparatus via corresponding slots and replaced in a hot swap manner.

8. A method of operating an uninterruptible power system; steps of the method comprising:
(a) providing a power distribution apparatus, the power distribution apparatus having a plurality of power supply units and configured to receive an external AC power;
(b) providing an interruptible power apparatus, the interruptible power apparatus having a plurality of power conversion modules and configured to receive an external DC power;
(c) converting the external AC power into a first DC output power by the power supply units to supply a DC load when the external AC power normally operates; and
(d) converting the external DC power into a second DC output power by the power conversion modules to supply the DC load when the external AC power abnormally operates.

9. The method of operating the uninterruptible power system in claim 8, wherein the power distribution apparatus and the interruptible power apparatus are configured to separately and independently supply the DC load.

10. The method of operating the uninterruptible power system in claim 8, wherein the power distribution apparatus is configured to produce a switch control signal and send the switch control signal to the interruptible power apparatus to transfer supplying the DC load from the power distribution apparatus to the interruptible power apparatus when the power distribution apparatus detects that the external AC power abnormally operates.

11. The method of operating the uninterruptible power system in claim 10, wherein the power distribution apparatus is configured to produce a resumption control signal and send the resumption control signal to the interruptible power apparatus to transfer supplying the DC load from the interruptible power apparatus to the power distribution apparatus when the power distribution apparatus detects that the external AC power normally operates.

12. The method of operating the uninterruptible power system in claim 8, wherein the external DC power is generated by a DC power supply apparatus; the DC power supply apparatus is a rechargeable battery, a fuel cell, or a renewable energy generation apparatus.

13. The method of operating the uninterruptible power system in claim 12, wherein the rechargeable battery is charged by an external charging apparatus to generate the external DC power.

14. The method of operating the uninterruptible power system in claim 8, wherein each of the power conversion modules is a power converter and the power conversion modules are electrically connected in parallel to each other.

15. The method of operating the uninterruptible power system in claim 8, wherein the power conversion modules are inserted in the interruptible power apparatus via corresponding slots and replaced in a hot swap manner.
